(19) United States
(12) Patent Application Publication
(10) Pub. No.: US 2021/0334751 A1
(43) Pub. Date: Oct. 28, 2021

(54) SHIPMENT PREDICTION METHOD AND DEVICE

(71) Applicant: HONGFUJIN PRECISION ELECTRONICS(TIANJIN)CO.,LTD., Tianjin (CN)

(72) Inventors: KAI-HSUN HSUEH, New Taipei (TW); LI-MING CHEN, Neihu (TW); YU-JEN CHANG, Neihu (TW); SHANG-YI LIN, New Taipei (TW)

(21) Appl. No.: 17/241,427

(22) Filed: Apr. 27, 2021

(30) Foreign Application Priority Data
Apr. 28, 2020 (CN) 202010351886.X

(51) Int. Cl. G06Q 10/08; G06Q 10/06; G06Q 10/10; G06N 3/04; G06N 3/08; G06F 16/245; G06F 16/28

(52) U.S. Cl. CPC G06Q 10/0875; G06Q 10/06315; G06Q 10/0838; G06F 16/284; G06N 3/04; G06N 3/08; G06F 16/245; G06Q 10/10

(57) ABSTRACT

A shipment prediction method and a shipment prediction device using the shipment prediction method obtains name of at least one material or product or object, and at least one number corresponding to the material name; a pre-trained material consumption prediction model is invoked, and consumption or usage of such material corresponding to the at least one number. A correspondence relation table between material numbers and product information is queried according to the quantities of material corresponding to the at least one number, and a shipment or dispatch of materials corresponding to the at least one number. The correspondence relation table records material numbers of all materials required for producing each product and a quantity of materials for each product and overall. The shipment prediction method and device renders shipment prediction more efficient and effective.

### CROSS-REFERENCE TO RELATED APPLICATIONS

This application claims priority to Chinese Patent Application No. 202010351886.X filed on Apr. 28, 2020, the contents of which are incorporated by reference herein.

### FIELD

The subject matter herein generally relates to predicting shipments in logistics, especially relating to a shipment prediction method and a shipment prediction device using the shipment prediction method.

### BACKGROUND

In the prior art, shipment prediction methods can use statistical analysis of labour to predict shipment in a preset time period. However, such analysis is generally inefficient and crude.

### BRIEF DESCRIPTION OF THE DRAWINGS

Implementations of the present disclosure will now be described, by way of embodiments, with reference to the attached figures.

FIG. 1 is a block diagram of one embodiment of a running environment of a shipment prediction method.

FIG. 2 illustrates a flowchart of one embodiment of a shipment prediction method of FIG. 1.

FIG. 3 is a block diagram of an embodiment of a shipment prediction device.

FIG. 4 is a diagram of an embodiment of a computer device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

Exemplary embodiments of the present disclosure will be described in relation to the accompanying drawings.

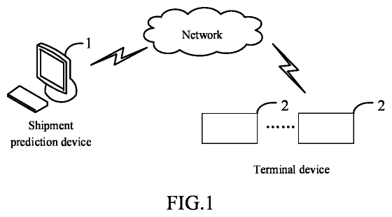

FIG. 1 illustrates an embodiment of a running environment of a shipment prediction method. The shipment prediction method is applied in a shipment prediction device 1. The shipment prediction device 1 communicates with a terminal device 2 by a network. In one embodiment, the network can be a wireless network, for example, the network can be a WI-FI network, a cellular network, a satellite network, or a broadcast network. In one embodiment, the terminal device 2 sends material number code to be queried. The shipment prediction device 1 predicts consumption of materials corresponding to the at least one material number code, and the materials are required for producing at least one type of products in a preset time period. The shipment prediction device 1 calculates a shipment of at least one type of products that correspond to the material number codes to a correspondence relation table between material number codes and production information. In one embodiment, the shipment prediction 1 can be an electronic device with a shipment prediction software, for example, the shipment prediction 1 can be a personal computer or a server. In one embodiment, the server can be a single server, a server cluster or a cloud server. In one embodiment, the terminal device 2 can be an electronic device with computing function and storage function. In on embodiment, the terminal device 2 can be a smartphone, a tablet, a laptop, a desktop computer, or a production equipment.

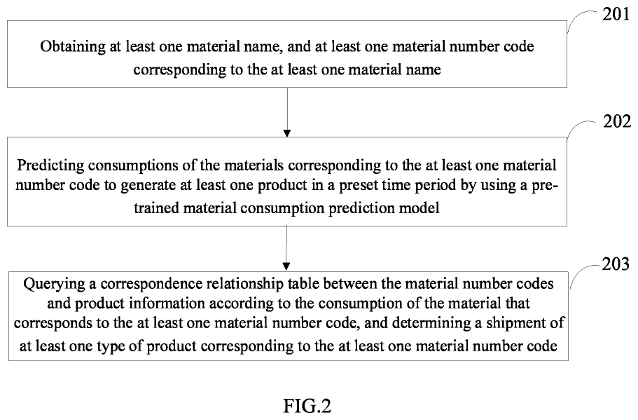

FIG. 2 illustrates the shipment prediction method. The method is provided by way of example, as there are a variety of ways to carry out the method. The method described below can be carried out using the operating environment illustrated in FIG. 1, for example, and various elements of the figure are referenced in explaining the example method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 201.

At block 201, the shipment prediction device 1 obtains at least one material name, and at least one material number code corresponding to the at least one material name.

In one embodiment, the material number code can be a combination of letters and numbers. The letters and the numbers in the material number code indicate material information, an installation position, a product type, a product brand a sale country or a sale region of material number corresponding to the material number code. For example, in one material number code of “ABC123”, the letter “A” indicates the material code of the material, and material information can be obtained by querying material code from a preset relationship table between the material codes and the materials. The letter “B” indicates an installation position of the material, and the installation position can be obtained by querying a preset relationship table between the installation position and the materials. The letter “C” can be a product type of a product corresponding to or derived from the material. The number “1” can be a brand of the product corresponding to the material, and the number “2” can be a sale country corresponding to the material, and the number “3” can be a sale region corresponding to the material.

At block 202, the shipment prediction device 1 predicts consumption of the material corresponding to the at least one material number code to generate at least one product in a preset time period by using a pre-trained material consumption prediction model.

In one embodiment, the material consumption prediction model analyzes feature relations between the at least one material number code and consumptions of the materials that are required for producing different types of products in a historical time period, and thereby predicts the consumptions of such materials for producing different types of the products in the preset time period based on the feature relations, and the material corresponding to the at least one material number code.

When a material number code is input into the material consumption prediction model, the material consumption prediction model predicts the consumptions of the materials corresponding to the material number code, and the materials are required for producing one type of product in the preset time period. In one embodiment, the preset time period can be set according to actual conditions, for example, the preset time period can be one week, or 21 days, or one month etc.

In one embodiment, the feature relations between the at least one material number code and the consumptions of the materials corresponding to the at least one material number code can be determined by a mathematical statistical method. For example, a mathematical statistical algorithm counts the material number code and the consumptions of the materials corresponding to the material number code in a historical time period, inputs the consumptions of the materials into the material consumption prediction model to analyze the consumptions of the materials corresponding to the at least one material number code, and the materials which are required for producing different types of products. In one embodiment, the mathematical statistical algorithm can be a Time Series Model, a Long Short-Term Memory Model, or a Hidden Markov Model.

In one embodiment, the feature relations between the at least one material number code and the consumptions of the materials corresponding to the at least one material number code that are required for producing different types of products can be determined by a deep learning model based on Convolutional Neural Networks.

A training process of the material consumption prediction model comprises:

collecting sample data, and splitting the sample data into a training set and a validation set, the sample data including shipping time of shipped products, material number codes of the shipped products, consumptions of the materials corresponding to the material number codes of the shipped products, and the shipping time of the shipped products and the material number codes of the shipped products being input data of the material consumption prediction model, and the consumptions of the materials corresponding to the material number codes of the shipped products being output data of the material consumption prediction model;

establishing a deep learning model based on Convolutional Neural Networks, training the deep learning model with the training set, and obtaining parameters of the deep learning model;

validating the trained deep learning model with the validation set to obtain first validation results, and calculating an accuracy of the deep learning model according to the first validation results;

determining whether the accuracy of the deep learning model is less than a preset threshold value;

determining the deep learning model as the material consumption prediction model in response that the accuracy of the deep learning is larger than or equal to the preset threshold value; or

modifying parameters of the deep learning model and re-training the modified deep learning model with the training set in response that the accuracy of the deep learning model is less than the second preset threshold value;

validating the re-trained deep learning model with the validation set to obtain second validation results, and calculating an accuracy of the re-trained deep learning model according to the second validation results;

determining the re-trained deep learning model as the material consumption prediction model in response that the recomputed accuracy of the re-trained deep learning is larger than or equal to the preset threshold value; or

modifying the parameters of the deep learning model and re-training the modified deep learning model with the training set in response that the accuracy of the deep learning model is less than the second preset threshold value, until the recomputed accuracy of the deep learning model is larger than or equal to the second preset threshold value;

wherein, the parameters of the deep learning model based on the Convolutional Neural Networks includes number of convolution kernels, number of elements in pooling layers, number of elements in fully connected layers, and connection relationship between different connected layers.

In one embodiment, the material consumption prediction model can be a deep learning model based on naive Bayesian algorithm, a deep learning model based on multi-classification support vector machine algorithm, a deep learning model based on logistic regression classification algorithm, or a deep learning model based on decision tree classification algorithm.

At block 203, the shipment prediction device 1 queries a correspondence relationship table between the material number codes and product information according to the consumption of the material that corresponds to the at least one material number code, and determines a shipment of at least one type of product corresponding to the at least one material number code.

In at least one embodiment, the correspondence relationship table between the material number codes and product information records material number codes of all materials required for producing products and consumptions of each of the materials.

In one embodiment, the shipment prediction device 1 obtains design drawings of the products and obtains the material name, the material number codes, and the consumptions of the materials from the design drawings of the products, and establishes the correspondence relationship table according to the material name, the material number codes, and the consumption of the material. In one embodiment, the design drawings record material number codes including spare parts of the products and numbers of the material number codes.

The shipment prediction device 1 obtains processing parameters of the products, and obtains consumable material information of the products, the material number code of consumable material, the consumptions of the consumable material from the processing parameters of the products. The shipment prediction device 1 establishes a correspondence relationship table between the material number codes and the product information according to the consumable material information of the products, the material number code of consumable material, and the consumption of the consumable material. The consumable material information can include materials lost in production, for example grinding wheels, developer solutions, etc.

In one embodiment, the shipment prediction device 1 outputs a material number list according to the shipment of the products. In one embodiment, the material number list includes the material name, the material numbers, the consumption of the materials. There are correspondence relations between different material number codes corresponding to one type of product. If the shipment of the product and the consumptions of the material corresponding to the material number code required for producing the product, are known, the consumptions of the materials corresponding to other material number codes, which are required for producing the product, can be computed according to the correspondence relations. In one embodiment, the shipment prediction device can output all material number codes that are required for producing the product, the material names corresponding to the material number codes, and the consumptions corresponding to the material names, in the form of data.

In one embodiment, the shipment prediction device queries, according to the material number list, whether a stored material number is larger than a required material number. The required material number is the consumption of the materials in the material number list. In one embodiment, the shipment prediction device generates a first prompt message when the stored material number is less than the consumption of the materials in the material number list. The first prompt message reminds staffs to timely purchase materials. In one embodiment, the first prompt message can be displayed in a form of text or a form of voice.

In one embodiment, the shipment prediction device calculates a difference between the quantity of stored material and the required quantity of material and compares the difference with a first preset threshold value in response that the quantity of stored material is larger than the required consumption of the material. The shipment prediction device generates a second prompt message indicating an excess of quantity in the inventory in response that the difference is larger than the first preset threshold value. The second prompt message reminds the staff of the excess inventory and that a new procurement plan needs to be made. The second prompt message can be displayed in the form of text or a form of voice.

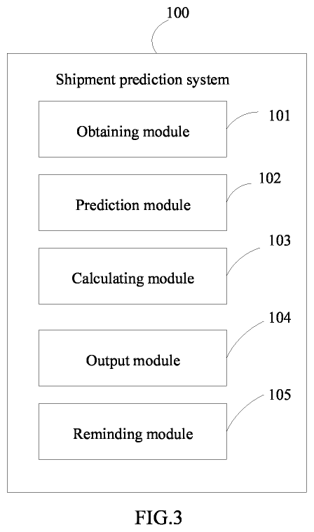

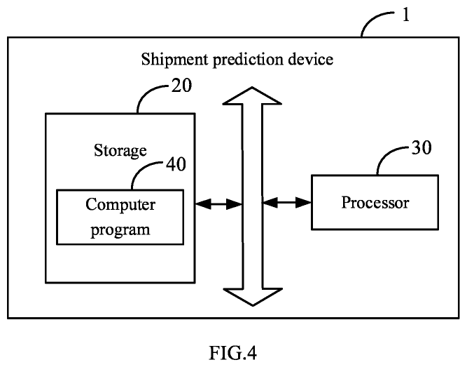

FIG. 2 illustrates a detailed introduction to the shipment prediction method of the disclosure. In combination with FIG. 3 and FIG. 4, the functional modules of a shipment prediction system to perform the shipment prediction method is described below.

It shall be understood that the embodiments described are for illustrative purposes only and are not limited by this structure in the scope of the patent application.

FIG. 3 illustrates the shipment prediction system 100. The shipment prediction system 100 is applied in the shipment prediction device 1. The shipment prediction device 1 communicates with at least one terminal device 2. The shipment prediction system 100 can be divided into a plurality of functional modules consisting of software instructions. The program codes of the shipment prediction device 1 can be stored in a storage of the shipment prediction device 1, and executed by at least one processor of the shipment prediction device 1 to perform the functions of shipment prediction.

In one embodiment, the shipment prediction system 100 includes, but is not limited to, an obtaining module 101, a prediction module 102, a calculating module 103, an output module 104, and a reminding module 105. The modules 101-105 of the shipment prediction system 100 can be collections of software instructions.

The obtaining module 101 obtains at least one material name, and at least one material number code corresponding to the at least one material name.

In one embodiment, the material number code can be a combination of letters and numbers. The letters and the numbers in the material number code can indicate material information, an installation position, a product type, a product brand a sale country or a sale region of material number corresponding to the material number code. For example, in one material number code of “ABC123”, the letter “A” indicates the material code of the material, and material information can be obtained by querying material code from a preset relationship table between the material codes and the materials. The letter “B” indicates an installation position of the material, and the installation position can be obtained by querying a preset relationship table between the installation position and the materials. The letter “C” can be a product type of a product corresponding to the material. The number “1” can be a brand of the product corresponding to the material, and the number “2” can be a sale country corresponding to the material, and the number “3” can be a sale region corresponding to the material.

The prediction module 102 predicts consumptions of the materials corresponding to the at least one material number code to generate at least one product in a preset time period by using a pre-trained material consumption prediction model.

In one embodiment, the material consumption prediction model analyzes feature relations between the at least one material number code and consumptions of the materials that are required for producing different types of products in a historical time period, and predicts the consumptions of the materials that are required for producing different types of the products in the preset time period based on the feature relations, and the material corresponding to the at least one material number code.

When a material number code is input into the material consumption prediction model, the material consumption prediction model predicts the consumptions of the materials corresponding to the material number code, and the materials are required for producing one type of product in the preset time period. In one embodiment, the preset time period can be set according to actual conditions, for example, the preset time period can be one month or 20 days, etc.

In one embodiment, the feature relations between the at least one material number code and the consumptions of the materials corresponding to the at least one material number code can be determined by a mathematical statistical method. For example, the mathematical statistical algorithm counts the material number code and the consumptions of the materials corresponding to the material number code in a historical time period, inputs the consumptions of the materials into the material consumption prediction model to analyze the consumptions of the materials corresponding to the at least one material number code, and the materials are required for producing different types of products. In one embodiment, the mathematical statistical algorithm can be a Time Series Model, a Long Short-Term Memory Model or a Hidden Markov Model.

In one embodiment, the feature relations between the at least one material number code and the consumptions of the materials corresponding to the at least one material number code that are required for producing different types of products can be determined by a deep learning model based on Convolutional Neural Networks.

The prediction module 102 performs a training process of the material consumption prediction model comprises:

collecting sample data, and splitting the sample data into a training set and a validation set, the sample data including shipping time of shipped products, material number codes of the shipped products, consumptions of the materials corresponding to the material number codes of the shipped products, and the shipping time of the shipped products and the material number codes of the shipped products being input data of the material consumption prediction model, and the consumptions of the materials corresponding to the material number codes of the shipped products being output data of the material consumption prediction model;

establishing a deep learning model based on Convolutional Neural Networks, training the deep learning model with the training set, and obtaining parameters of the deep learning model;

validating the trained deep learning model with the validation set to obtain first validation results, and calculating an accuracy of the deep learning model according to the first validation results;

determining whether the accuracy of the deep learning model is less than a preset threshold value;

determining the deep learning model as the material consumption prediction model in response that the accuracy of the deep learning is larger than or equal to the preset threshold value; or

modifying parameters of the deep learning model and re-training the modified deep learning model with the training set in response that the accuracy of the deep learning model is less than the second preset threshold value;

validating the re-trained deep learning model with the validation set to obtain second validation results, and calculating an accuracy of the re-trained deep learning model according to the second validation results;

determining the re-trained deep learning model as the material consumption prediction model in response that the recomputed accuracy of the re-trained deep learning is larger than or equal to the preset threshold value; or

modifying the parameters of the deep learning model and re-training the modified deep learning model with the training set in response that the accuracy of the deep learning model is less than the second preset threshold value, until the recomputed accuracy of the deep learning model is larger than or equal to the second preset threshold value;

wherein, the parameters of the deep learning model based on the Convolutional Neural Networks includes number of convolution kernels, number of elements in pooling layers, number of elements in fully connected layers, connection relationship between different connected layers.

In one embodiment, the material consumption prediction model can be one of a deep learning model based on naive Bayesian algorithm, a deep learning model based on multi-classification support vector machine algorithm, a deep learning model based on logistic regression classification algorithm, a deep learning model based on decision tree classification algorithm.

The calculating module 103 queries a correspondence relationship table between the material number codes and product information according to the consumption of the material corresponding to the at least one material number code, and determines a shipment of at least one type of product that corresponds to the at least one material number code.

In at least one embodiment, the correspondence relationship table between the material number codes and product information records material number codes of all materials required for producing product and consumptions of each of the materials.

In one embodiment, the calculating module 103 obtains design drawings of the products and obtains the material name, the material number codes and the consumptions of the materials from the design drawings of the products, and establishes the correspondence relationship table according to the material name, the material number codes and the consumption of the material. In one embodiment, the design drawings record material number codes of each spare part of the products and numbers of the material number codes.

The calculating module 103 obtains processing parameters of the products, and obtains consumable material information of the products, the material number code of consumable material, the consumptions of the consumable material from the processing parameters of the products. The calculating module 103 establishes a correspondence relationship table between the material number codes and the product information according to the consumable material information of the products, the material number code of consumable material, the consumption of the consumable material. The consumable material information can be materials lost in production, for example grinding wheels, developer solutions, etc.

In one embodiment, the output module 104 outputs a material number list according to the shipment of the products. In one embodiment, the material number list includes the material name, the material numbers, the consumption of the materials. There are correspondence relations between different material number codes corresponding to one type of products. In response that the shipment of the product and the consumptions of the material corresponding to the material number code, which is required for producing the product, are known, the consumptions of the materials corresponding to other material number codes, which are required for producing the product, can be computed according to the correspondence relations. In one embodiment, the calculating module 103 can output all material number codes that are required for producing the product, the material names corresponding to the material number codes and the consumptions corresponding to the material names in the form of data.

In one embodiment, the reminding module 105 queries, according to the material number list, whether a stored material number is larger than a required material number. The required material number is the consumption of the materials in the material number list. In one embodiment, the calculating module 103 generates a first prompt message when the stored material number is less than the consumption of the materials in the material number list. The first prompt message reminds staffs to timely purchase materials. In one embodiment, the first prompt message can be displayed in a form of text or a form of voice.

In one embodiment, the reminding module 105 calculates a difference between the stored material number and the required material number and compares the difference with a first preset threshold value in response that the stored material number is larger than the consumption of the material. The reminding module 105 generates a second prompt message indicating an excessive inventory in response that the difference is larger than the first preset threshold value. The second prompt message reminds the staffs of the excessive inventory and that a new procurement plan needs to be made. The second prompt message can be displayed in the form of text or a form of voice.

FIG. 4 illustrates the shipment prediction device 1.

The shipment prediction device 1 includes a storage 20, a processor 30, and a computer program 40, such as a shipment prediction program, which is stored in the storage 20 and can be operated on the processor 30. The processor 30 implements the blocks in the above embodiments of the shipment prediction method when the processor 30 executes the computer program 40, such as blocks 201˜202 shown in FIG. 2. Alternatively, the processor 30 performs the functions of each module/unit in the embodiment of the shipment prediction device when the processor 30 executes the computer program 40, such as modules 101-105 in FIG. 3.

Exemplary, the computer program 40 can be divided into one or more modules/units, the one or more modules/units are stored in the storage 20 and executed by the processor 30 to complete the invention. The one or more modules/units may be a series of computer program instruction segments, the series of computer program instruction segments are used to complete a specific function, and the instruction segments are used to describe the execution of the computer program 40 in the shipment prediction device 1. For example, the computer program 40 can be divided into the obtaining module 101, the prediction module 102, the calculating module 103, an output module 104, and a reminding module 105 as shown in FIG. 3.

The shipment prediction device 1 can be a desktop computer, a laptop computer, a handheld computer, a cloud server or other computing devices. There are no limitations of the shipment prediction device 1, and other examples may include more or less components than those illustrated, or some components may be combined, or have a different arrangement. The components, such as the shipment prediction device 1, may also include input devices, output devices, communication unit, network access devices, buses, and the like.

The processor 30 can be a central processing unit (CPU), and also include other general-purpose processors, a digital signal processor (DSP), and application specific integrated circuit (ASIC), Field-Programmable Gate Array (FPGA) or other programmable logic device, discrete gate or transistor logic device, discrete hardware components, etc. The processor 30 may be a microprocessor or the processor 30 may be any conventional processor or the like. The processor 30 is the control center of the shipment prediction device 1, and connects the entire shipment prediction device 1 by using various interfaces and lines.

The storage 20 stores the computer program 40 and/or modules/units, the processor 30 performs functions of the shipment prediction device 1 through operating or executing the computer program 40 and/or modules/units stored in the storage 20 and invoking data stored in storage the storage 20. The storage 20 can include program storage area and data storage area, wherein, the program storage area stores operating systems and application program required by at least on function, such as sound playing function and image display function, the data storage area stores data created according to the using of the shipment prediction device 1, such as audio data and phone books. In at least one exemplary embodiment, the storage 20 can include high speed semirandom access storage mediums and non-volatile storage mediums. For example, the storage 20 can be a hard disk, an internal storage, a plug-in hard disk, a Smart Media Card, a Secure Digital Card, a Flash Memory Card, at least one disk storage device, flash memory device, or other volatile solid state storage device.

In one embodiment, the modules/units integrated in the shipment prediction device 1 can be stored in a computer readable storage medium if such modules/units are implemented in the form of a product. Thus, the present disclosure may be implemented and realized in any part of the method of the foregoing embodiments, or may be implemented by the computer program, which may be stored in the computer readable storage medium. The steps of the various method embodiments described above may be implemented by a computer program when executed by a processor. The computer program includes computer program code, which may be in the form of source code, object code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM), electrical carrier signals, telecommunication signals, and software distribution media.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

In one embodiment, the modules/units integrated in the navigation device can be stored in a computer readable storage medium if such modules/units are implemented in the form of a product. Thus, the present disclosure may be implemented and realized in any or part of the method of the foregoing embodiments, or may be implemented by the computer program, which may be stored in the computer readable storage medium. The steps of the various method embodiments described above may be implemented by a computer program when executed by a processor. The computer program includes computer program code, which may be in the form of source code, object code form, executable file or some intermediate form. The computer readable medium may include any entity or device capable of carrying the computer program code, a recording medium, a USB flash drive, a removable hard disk, a magnetic disk, an optical disk, a computer memory, a rad-only memory (ROM), random access memory (RAM), electrical carrier signals, telecommunication signals, and software distribution media.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A shipment prediction device comprising:
a processor; and
a non-transitory storage medium coupled to the processor and configured to store a plurality of instructions, which cause the processor to:
obtain at least one material name, and at least one material number code corresponding to the at least one material name;
predict consumptions of materials corresponding to the at least one material number code to generate at least one product in a preset time period by using a pre-trained material consumption prediction model, wherein the material consumption prediction model analyzes feature relations between the at least one material number code and consumptions of the materials that are required for producing different types of products, and predicts the consumptions of the materials based on the feature relations, and the material corresponding to the at least one material number code;
query a correspondence relationship table between the material number codes and product information according to the consumption of the material corresponding to the at least one material number code, and determine a shipment of at least one type of product that corresponds to the at least one material number code.

2. The shipment prediction device according to claim 1, wherein the plurality of instructions further cause the processor to:
output a material number list according to the shipment of the products, wherein the material number list includes the material name, the material numbers, the consumption of the materials.

3. The shipment prediction device according to claim 2, wherein the plurality of instructions further cause the processor to:
query, according to the material number list, whether a stored material number is larger than a required material number, and the required material number is the consumption of the materials in the material number list;
generate a first prompt message when the stored material number is less than the consumption of the materials in the material number list.

4. The shipment prediction device according to claim 3, wherein the plurality of instructions further cause the processor to:
calculate a difference between the stored material number and the required material number and compare the difference with a first preset threshold value in response that the stored material number is larger than the consumption of the material;
generate a second prompt message indicating an excessive inventory in response that the difference is larger than the first preset threshold value.

5. The shipment prediction device according to claim 1, wherein the plurality of instructions further configured to cause the processor to execute a training process of the material consumption prediction model, comprising:
collecting sample data, and splitting the sample data into a training set and a validation set, the sample data comprising shipping time of shipped products, material number codes of the shipped products, consumptions of the materials corresponding to the material numbers of the shipped products, wherein the shipping time of the shipped products and the material number codes of the shipped products are determined to be input data of the material consumption prediction model, and the consumptions of the materials corresponding to the material numbers of the shipped products are determined to be output data of the material consumption prediction model;
establishing a deep learning model based on Convolutional Neural Networks, training the deep learning model with the training set, and obtaining parameters of the deep learning model;
validating the trained deep learning model with the validation set to obtain first validation results, and calculating an accuracy of the deep learning model according to the first validation results;
determining whether the accuracy of the deep learning model is less than a second preset threshold value;
determining the deep learning model as the material consumption prediction model in response that the accuracy of the deep learning is larger than or equal to the second preset threshold value.

6. The shipment prediction device according to claim 5, wherein the plurality of instructions further cause the processor to:
after determining whether the accuracy of the deep learning model is less than the second preset threshold value, modify parameters of the deep learning model and re-train the modified deep learning model with the training set in response that the accuracy of the deep learning model is less than the second preset threshold value;
validate the re-trained deep learning model with the validation set to obtain second validation results, and calculate an accuracy of the re-trained deep learning mode according to the second validation results;
determine the re-trained deep learning model as the material consumption prediction model in response that the accuracy of the re-trained deep learning is larger than or equal to the second preset threshold value;
modify the parameters of the deep learning model and re-train the modified deep learning model with the training set in response that the accuracy of the deep learning model is less than the second preset threshold value, until the recomputed accuracy of the deep learning model is larger than or equal to the second preset threshold value;
wherein, the parameters of the deep learning model based on Convolutional Neural Networks comprises at least one of a quantity of convolution kernels, a quantity of elements in pooling layers, a quantity of elements in fully connected layers, connection relationship between different fully connected layers.

7. The shipment prediction device according to claim 1, wherein the plurality of instructions further cause the processor to:
obtain design drawings of the products and obtain the material name, the material number codes and the consumptions of the materials from the design drawings of the products, and establish the correspondence relationship table according to the material name, the material number codes and the consumption of the material;
obtain processing parameters of the products, and obtain consumable material information of the products, the material number code of consumable material, the consumptions of the consumable material from the processing parameters of the products.

8. A shipment prediction method, comprising:
obtaining at least one material name, and at least one material number code corresponding to the at least one material name;
predicting consumptions of materials corresponding to the at least one material number code to generate at least one product in a preset time period by using a pre-trained material consumption prediction model, wherein the material consumption prediction model analyzes feature relations between the at least one material number code and consumptions of the materials that are required for producing different types of products, and predicts the consumptions of the materials based on the feature relations, and the material corresponding to the at least one material number code;
querying a correspondence relationship table between the material number codes and product information according to the consumption of the material corresponding to the at least one material number code, and determining a shipment of at least one type of product that corresponds to the at least one material number code.

9. The shipment prediction method according to claim 8, further comprising:
outputting a material number list according to the shipment of the products, wherein the material number list includes the material name, the material numbers, the consumption of the materials.

10. The shipment prediction method according to claim 9, further comprising:
querying, according to the material number list, whether a stored material number is larger than a required material number, and the required material number is the consumption of the materials in the material number list;
generating a first prompt message when the stored material number is less than the consumption of the materials in the material number list.

11. The shipment prediction method according to claim 10, further comprising:
calculating a difference between the stored material number and the required material number and comparing the difference with a first preset threshold value in response that the stored material number is larger than the consumption of the material;
generating a second prompt message indicating an excessive inventory in response that the difference is larger than the first preset threshold value.

12. The shipment prediction method according to claim 8, further comprising:
executing a training process of the material consumption prediction model, comprising:
collecting sample data, and splitting the sample data into a training set and a validation set, the sample data comprising shipping time of shipped products, material number codes of the shipped products, consumptions of the materials corresponding to the material numbers of the shipped products, wherein the shipping time of the shipped products and the material number codes of the shipped products are determined to be input data of the material consumption prediction model, and the consumptions of the materials corresponding to the material numbers of the shipped products are determined to be output data of the material consumption prediction model;
establishing a deep learning model based on Convolutional Neural Networks, training the deep learning model with the training set, and obtaining parameters of the deep learning model;
validating the trained deep learning model with the validation set to obtain first validation results, and calculating an accuracy of the deep learning model according to the first validation results;
determining whether the accuracy of the deep learning model is less than a second preset threshold value;
determining the deep learning model as the material consumption prediction model in response that the accuracy of the deep learning is larger than or equal to the second preset threshold value.

13. The shipment prediction method according to claim 12, further comprising:
after determining whether the accuracy of the deep learning model is less than the second preset threshold value, modifying parameters of the deep learning model and re-training the modified deep learning model with the training set in response that the accuracy of the deep learning model is less than the second preset threshold value;
validating the re-trained deep learning model with the validation set to obtain second validation results, and calculating an accuracy of the re-trained deep learning mode according to the second validation results;
determining the re-trained deep learning model as the material consumption prediction model in response that the accuracy of the re-trained deep learning is larger than or equal to the second preset threshold value;
modifying the parameters of the deep learning model and re-train the modified deep learning model with the training set in response that the accuracy of the deep learning model is less than the second preset threshold value, until the recomputed accuracy of the deep learning model being larger than or equal to the second preset threshold value;
wherein, the parameters of the deep learning model based on Convolutional Neural Networks comprises at least one of a quantity of convolution kernels, a quantity of elements in pooling layers, a quantity of elements in fully connected layers, connection relationship between different fully connected layers.

14. The shipment prediction method according to claim 12, further comprising:
obtaining design drawings of the products and obtain the material name, the material number codes and the consumptions of the materials from the design drawings of the products, and establishing the correspondence relationship table according to the material name, the material number codes and the consumption of the material;
obtaining processing parameters of the products, and obtaining consumable material information of the products, the material number code of consumable material, the consumptions of the consumable material from the processing parameters of the products.

15. A non-transitory storage medium having stored thereon instructions that, when executed by at least one processor of a shipment prediction device, causes the least one processor to execute a shipment prediction method, the shipment prediction method comprising:
obtaining at least one material name, and at least one material number code corresponding to the at least one material name;
predicting consumptions of materials corresponding to the at least one material number code to generate at least one product in a preset time period by using a pre-trained material consumption prediction model, wherein the material consumption prediction model analyzes feature relations between the at least one material number code and consumptions of the materials that are required for producing different types of products, and predicts the consumptions of the materials based on the feature relations, and the material corresponding to the at least one material number code;
querying a correspondence relationship table between the material number codes and product information according to the consumption of the material corresponding to the at least one material number code, and determining a shipment of at least one type of product that corresponds to the at least one material number code.

16. The non-transitory storage medium as recited in claim 15, wherein the shipment prediction method further comprises:
outputting a material number list according to the shipment of the products, wherein the material number list includes the material name, the material numbers, the consumption of the materials.

17. The non-transitory storage medium as recited in claim 16, wherein the shipment prediction method further comprises:
querying, according to the material number list, whether a stored material number is larger than a required material number, and the required material number is the consumption of the materials in the material number list;
generating a first prompt message when the stored material number is less than the consumption of the materials in the material number list.

18. The non-transitory storage medium as recited in claim 17, wherein the shipment prediction method further comprises:
calculating a difference between the stored material number and the required material number and comparing the difference with a first preset threshold value in response that the stored material number is larger than the consumption of the material;
generating a second prompt message indicating an excessive inventory in response that the difference is larger than the first preset threshold value.

19. The non-transitory storage medium as recited in claim 15, wherein the shipment prediction method further comprises:
executing a training process of the material consumption prediction model, comprising:
collecting sample data, and splitting the sample data into a training set and a validation set, the sample data comprising shipping time of shipped products, material number codes of the shipped products, consumptions of the materials corresponding to the material numbers of the shipped products, wherein the shipping time of the shipped products and the material number codes of the shipped products are determined to be input data of the material consumption prediction model, and the consumptions of the materials corresponding to the material numbers of the shipped products are determined to be output data of the material consumption prediction model;
establishing a deep learning model based on Convolutional Neural Networks, training the deep learning model with the training set, and obtaining parameters of the deep learning model;
validating the trained deep learning model with the validation set to obtain first validation results, and calculating an accuracy of the deep learning model according to the first validation results;
determining whether the accuracy of the deep learning model is less than a second preset threshold value;
determining the deep learning model as the material consumption prediction model in response that the accuracy of the deep learning is larger than or equal to the second preset threshold value.

20. The non-transitory storage medium as recited in claim 15, wherein the shipment prediction method further comprises:
after determining whether the accuracy of the deep learning model is less than the second preset threshold value, modifying parameters of the deep learning model and re-training the modified deep learning model with the training set in response that the accuracy of the deep learning model is less than the second preset threshold value;
validating the re-trained deep learning model with the validation set to obtain second validation results, and calculating an accuracy of the re-trained deep learning mode according to the second validation results;
determining the re-trained deep learning model as the material consumption prediction model in response that the accuracy of the re-trained deep learning is larger than or equal to the second preset threshold value;
modifying the parameters of the deep learning model and re-train the modified deep learning model with the training set in response that the accuracy of the deep learning model is less than the second preset threshold value, until the recomputed accuracy of the deep learning model being larger than or equal to the second preset threshold value;
wherein, the parameters of the deep learning model based on Convolutional Neural Networks comprises at least one of a quantity of convolution kernels, a quantity of elements in pooling layers, a quantity of elements in fully connected layers, connection relationship between different fully connected layers.
